(19) United States
(12) Patent Application Publication
(10) Pub. No.: US 2010/0259863 A1
(43) Pub. Date: Oct. 14, 2010

(54) Static Eliminating bracelet

(76) Inventor: Chun-An Yuan, Sanchong City (TW)

Correspondence Address: CHUN-AN YUAN, P.O.BOX 44-2049, Taipei, 10668, TW

(21) Appl. No.: 12/385,562

(22) Filed: Apr. 13, 2009

(51) Int. Cl. H05F 3/02

(52) U.S. Cl. 361/220

(57) ABSTRACT

A static eliminating bracelet includes a main part and a rivet rotatably fixes a wire fixing member to the top of the main part. A first conductive board is connected to an underside of the main part and a second conductive board is located in the passage of the main part and includes a top plate and a bottom plate. The top plate is connected to the rivet and a conductive positioning member is connected between the bottom plate and the first conductive board. A conductive cable has a first end electrically fixed to the first conductive board, the bottom plate and the underside of the main part. A second end of the cable extends through the space between of the top and bottom plates and is pressed by a locking plate. The second end of the cable contacts the bottom plate and located beneath the locking plate.

### BACKGROUND OF THE INVENTION

(1) Field of the Invention

The present invention relates to a bracelet, and more particularly, to a static eliminating bracelet wherein the end of the cable does not interrupt rotation of the wire fixing member.

(2) Description of the Prior Art

Elimination of static is an import process for manufacture of electronic products because the electrostatic can make the electronic products have flaws. The persons who are going to manufacture the electronic products have to remove the electrostatic from their body by wearing a static eliminating bracelet which transfers the electrostatic from the wearer's body to the static eliminator or the ground. Nevertheless, the sizes of different wearers are not the same so that each person has to adjust the static eliminating bracelet before wearing it.

As shown in FIG. 1, a conventional static eliminating bracelet 10 generally includes main part 11, a rivet 12, a conductive board 13, a locking plate 14 and a cable 15. The main part 11 includes two open ends and a space is defined therein, the cable 15 extends through the space. The conductive board 13 is connected to the underside of the main part 11 and the rivet 12 extends through the main part 11 from the top of the main part 11 so as to connect the conductive board 13. The locking plate 14 is pivotably connected to one end of the main part 11. The cable 15 has a first end fixed by the rivet 12 and contacts the conductive board 13. The second end of the cable 15 is locked by the locking plate 14, wherein a distal end 151 of the second end of the cable 15 extends upward from the main part 11 if the bracelet 10 is adjusted to have a smaller size.

The locking plate 14 can be pivoted upward and the second end of the cable 15 can be pulled to have a desired size, the locking plate 14 is then pivoted downward to position the second end of the cable 15. A wire 16 connected with a wire fixing member 161 is connected to the main part 11 and the rivet 12 fixes the wire fixing member 161 to the main part 11. The wire 16 is connected with a static eliminator which is not shown.

It is noted that the distal end of the second end of the cable 15 extends upward and can be easily in contact with the products to transfer electrostatic to the products. Besides, the distal end of the second end of the cable 15 extends upward and is located beside the wire fixing member 161, so that the wire fixing member 161 easily twists or even has cracks when the wire fixing member 161 rotates to hit the distal end 151 of the cable 15. There is only one conductive board 13 so that the electrostatic on the distal end 151 of the cable 15 has to travel a long distance to be transferred to the wire 16, this affects the efficiency. Furthermore, the exposed distal end 151 of the cable 15 easily tangles objects to unlock the locking plate 14. Some users may be allergic to the metallic conductive board 13 which is located at the underside of the main part 11.

The present invention intends to provide a static eliminating bracelet wherein the distal end of the cable does not extend upward from the main part and does not contact objects. The rotation of the wire fixing member is not interrupted by the distal end of the cable.

### SUMMARY OF THE INVENTION

The present invention relates to a static eliminating bracelet which comprises a main part having a passage defined through two ends thereof and a rivet is rotatably connected to a top of a first end of the of the main part so as to position a wire fixing member to the top of the main part. A wire is connected to the wire fixing member. A locking plate is pivotably connected to a second end of the main part and a first conductive board is connected to an underside of the second end of the main part.

A second conductive board is located in the passage and includes a top plate connected to the rivet and a bottom plate connected to a conductive positioning member which is connected between the bottom plate and the first conductive board. A conductive cable has a first end electrically fixed to the first conductive board, the bottom plate and the underside of the main part, and a second end of the cable extends through the space between the top and bottom plates and is pressed by the locking plate. The second end of the cable is in contact with the bottom plate. The distal end of the second end of the cable is located beneath the locking plate and does not interrupt rotation of the wire fixing member.

The primary object of the present invention is to provide a static eliminating bracelet wherein the distal end of the cable is located beneath the locking plate so that it does not contact the product and does no affect the rotation of the wire fixing member.

Another object of the present invention is to provide a static eliminating bracelet which includes two conductive boards to shorten the distance that the electrostatic travels.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a conventional static eliminating bracelet;

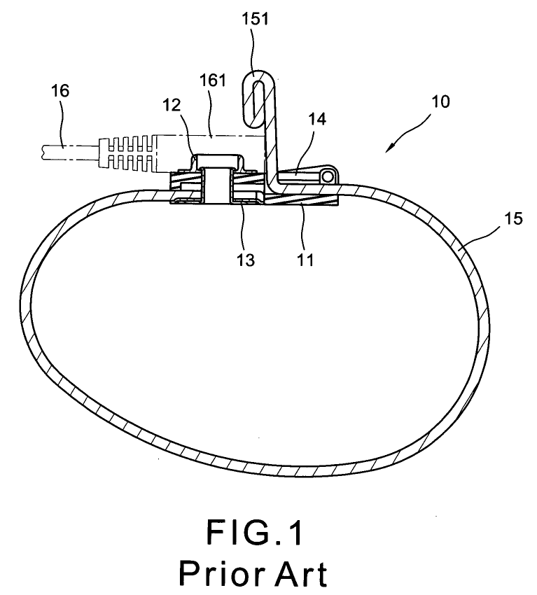

FIG. 2 is an exploded view to show the static eliminating bracelet of the present invention;

FIG. 3 is a perspective view to show the static eliminating bracelet of the present invention;

FIG. 4 is a cross sectional view of static eliminating bracelet of the present invention, wherein the locking plate is opened;

FIG. 5 is a cross sectional view of static eliminating bracelet of the present invention, wherein the locking plate is pressed, and

FIG. 6 is a cross sectional view of a second embodiment of the static eliminating bracelet of the present invention, wherein the locking plate is opened.

### DETAILED DESCRIPTION OF THE PREFERRED EMBODIMENTS

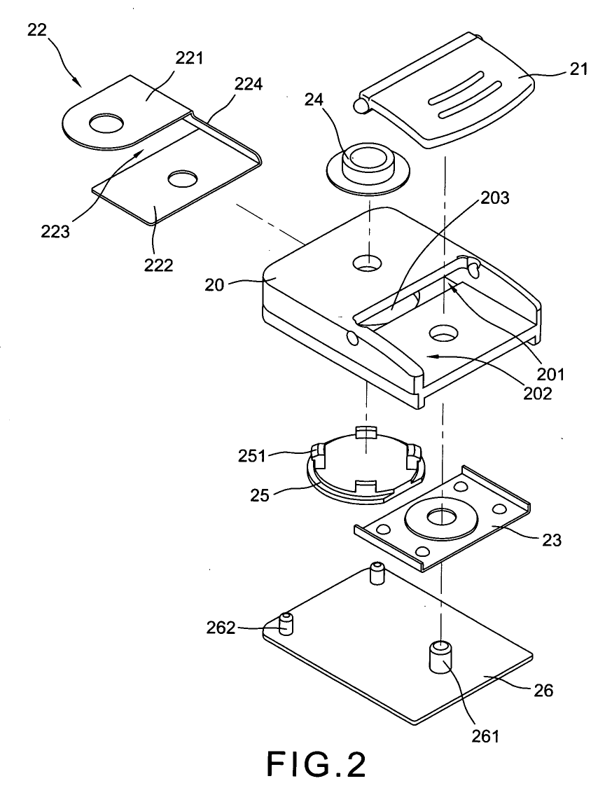

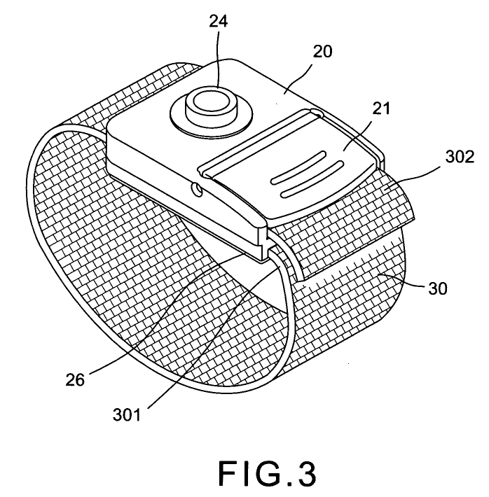

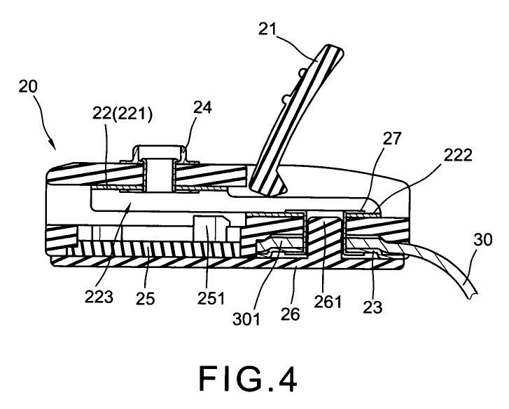

Referring to FIGS. 2 to 5, the static eliminating bracelet of the present invention comprises a main part 20 which has a passage 201 defined through two ends thereof and a rivet 24 is rotatably connected to a top of a first end of the main part 20. The second end of the main part 20 has a recessed area 202 defined in a second end thereof and a locking plate 21 is pivotably located in the recessed area 202. The rivet 24 positions a wire fixing member 32 to the top of the main part 20 and a wire 31 is connected to the wire fixing member 32. The wire 31 is connected to a static eliminator which is not shown. A first conductive board 23 is connected to an underside of the second end of the main part 20. A circular hole 203 is defined through the first end of the underside of the main part 20 and sealed by a circular cover 25. The circular cover 25 includes multiple hooks 251 extending from a periphery thereof so as to be hooked to the periphery of the circular hole 201.

A second conductive board 22 is located in the passage 201 of the main part 20 and includes a top plate 221 and a bottom plate 222. A connection plate 224 is connected between the top plate 221 and the bottom plate 222. A space 223 is located between the top and bottom plates 221, 222. The top plate 221 is connected to the rivet 24 and a conductive positioning member 27 is connected between the bottom plate 222 and the first conductive board 23. The first conductive board 23 is located on the bottom plate 222, the positioning member 27 extends through the first conductive board 23 is located on the bottom plate 222. The positioning member 27 is a rivet. The positioning member 27 includes a groove with in the first conductive board 23, the bottom plate 222 and the first end of the cable 30 are securely engaged.

A bottom cover 26 is connected to the underside of the main part 20 and includes a first positioning post 261 and multiple second positioning posts 262 extending from a top thereof. The first post 261 is inserted into a central passage of the positioning member 27 and the second posts 262 are inserted into holes (not shown) in the underside of the main part 20.

A conductive cable 30 has a first end electrically fixed to the first conductive board 23, the bottom plate 222 and the underside of the main part 20, and a second end of the cable 30 extends through the space 223 and is pressed by the locking plate 21. The second end of the cable 30 is in contact with the bottom plate 222. A distal end of the second end of the cable 30 is located beneath the locking plate 21.

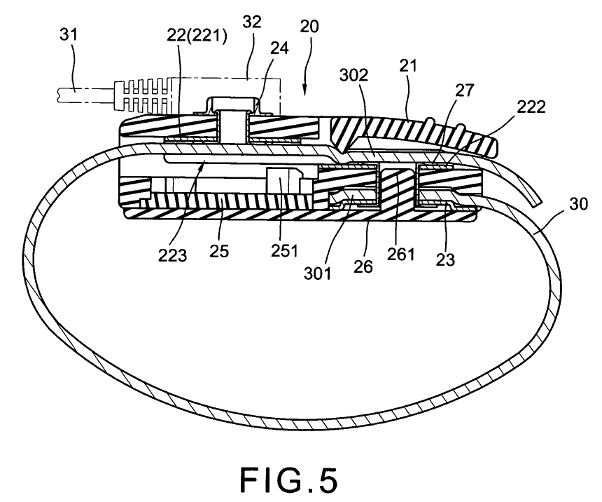

The user can pivot the locking plate 21 to unlock the second end of the cable 30 to adjust the size of the static eliminating bracelet, when the second end of the cable 30 is adjusted to a desired position, the locking plate 21 is then pivoted downward to lock the second end of the cable 30 as shown in FIG. 5.

It is noted that the distal end of the second end of the cable 30 is located beneath the locking plate 21 so that it does not tangle objects and avoid unintentional unlock of the locking plate 21. Besides, because the second end of the cable 30 is located beneath the locking plate 21, it does not affect rotation of the wire fixing member 32 at all.

Because the bottom plate 222 and the top plate 221 is a one-piece member, and the positioning member 27 is made of conductive material and in contact with the first conductive board 23 and the bottom plate 222, so that the electrostatic on the first end 301 of the cable 30 cab travels fast to the bottom plate 222 and the wire 31 via the rivet 24. The second end of the cable 30 is pressed by the locking plate 21 and in contact with the bottom plate 222, so that the electrostatic travels a short distance and can eliminated quickly.

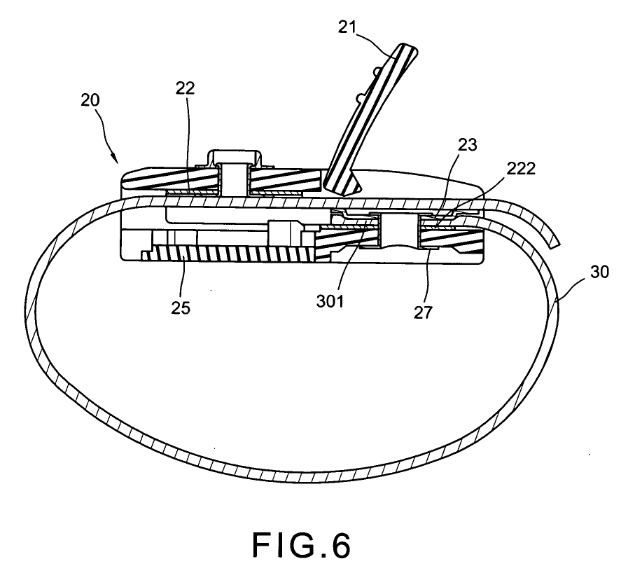

FIG. 6 shows a second embodiment of the static eliminating bracelet of the present invention, wherein the first conductive board 23 is located beneath the bottom plate 222 and the first end 301 of the cable 30 is located between the first conductive board 23 is located beneath the bottom plate 222. The positioning member 27 electrically connects the first conductive board 23, the bottom plate 222 and the first end 301 of the cable 30, so that the second embodiment of the static eliminating bracelet has the same function as the first embodiment.

The distal end of the second end 302 of the cable 30 does not exposed and hidden by the locking plate 21 so that the second end 302 does not contact the products and the rotation of the wire fixing member 32 is not interrupted by the second end 302. The bottom plate 222 of the second conductive board 22 transfers the electrostatic from the cable 30 directly so that the elimination of static is quick and efficient. The hidden distal end of the second end 302 of the cable 30 does not or tangle objects to unlock the locking plate 21. The static eliminating bracelet of the present invention has a bottom cover 26 which separates the wearer's skin from direct contact with the metallic material so as to prevent allergy to some wearers.

While we have shown and described the embodiment in accordance with the present invention, it should be clear to those skilled in the art that further embodiments may be made without departing from the scope of the present invention.

What is claimed is:

1. A static eliminating bracelet comprising:
a main part having a passage defined through two ends thereof and a rivet rotatably connected to a top of a first end of the of the main part, the rivet positioning a wire fixing member to the top of the main part and a wire is connected to the wire fixing member, a locking plate pivotably connected to a second end of the main part, a first conductive board connected to an underside of the second end of the main part;
a second conductive board located in the passage of the main part and having a top plate and a bottom plate, a space located between the top and bottom plates, the top plate connected to the rivet and a conductive positioning member connected between the bottom plate and the first conductive board, and
a conductive cable having a first end electrically fixed to the first conductive board, the bottom plate and the underside of the main part, a second end of the cable extending through the space and pressed by the locking plate and being in contact with the bottom plate, a distal end of the second end of the cable located beneath the locking plate.

2. The static eliminating bracelet as claimed in claim 1, wherein the positioning member is a rivet and includes a groove with in the first conductive board, the bottom plate and the first end of the cable are securely engaged.

3. The static eliminating bracelet as claimed in claim 1, wherein the rivet fixes the top plate to the main part.

4. The static eliminating bracelet as claimed in claim 1, wherein a circular hole is defined through the first end of the underside of the main part and sealed by a circular cover.

5. The static eliminating bracelet as claimed in claim 4, the circular cover includes multiple hooks extending from a periphery thereof.

6. The static eliminating bracelet as claimed in claim 2, wherein a bottom cover is connected to the underside of the main part.

7. The static eliminating bracelet as claimed in claim 6, wherein the bottom cover includes a first positioning post and multiple second positioning posts extending from a top thereof.

8. The static eliminating bracelet as claimed in claim 1, wherein the second end of the main part has a recessed area with which the locking plate is located.

9. The static eliminating bracelet as claimed in claim 1, wherein a connection plate is connected between the top plate and the bottom plate.

10. The static eliminating bracelet as claimed in claim 1, wherein the first conductive board is located on the bottom plate, the positioning member extends through the first conductive board is located on the bottom plate, the positioning member is a rivet.
